(19) United States
(12) Patent Application Publication
(10) Pub. No.: US 2006/0192859 A1
(43) Pub. Date: Aug. 31, 2006

(54) ELECTRONIC DEVICE WITH CAMERA AND MAIN MODULE INCORPORATED IN ELECTRONIC DEVICE WITH CAMERA

(75) Inventor: Gen SASAKI, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MegaChips LSI Solutions Inc., Osaka-shi (JP)

(21) Appl. No.: 11/275,981

(22) Filed: Feb. 8, 2006

(30) Foreign Application Priority Data
Feb. 28, 2005 (JP) 2005-053099

(51) Int. Cl. H04N 5/228

(52) U.S. Cl. 348/222.1

(57) ABSTRACT

Concerning increasingly downsized electronic devices equipped with cameras, an object of the present invention is to achieve easy adaptability of parts. A camera module includes an image sensor and a flash memory, and a main module includes an image processing unit and an SDRAM, and the two modules are connected through a flexible cable. The flash memory stores an image processing program for controlling the image processing unit. The image processing program is a program adapted for the camera module. The flash memory also stores adjustment data that is peculiar to the camera module. When the camera function is turned on, the program is downloaded to the main module and image processing is performed.

### BACKGROUND OF THE INVENTION

1. Field of the Invention

The present invention relates to an electronic device having a camera function in addition to its original functions.

2. Description of the Background Art

The size and cost reductions of image processing circuits and image sensors such as CCDs are promoting the production of electronic devices that are equipped with camera functions in addition to their original functions. For example, such electronic devices include mobile phone devices equipped with cameras and personal digital assistants (PDAs) equipped with cameras.

However, the camera function is a function that is not originally intended for the mobile phone devices and personal digital assistants. Accordingly, in general, camera modules for realizing the camera function are produced not in the factories that manufacture the electronic devices but in other factories, and the electronic device manufacturers acquire the produced camera modules and assemble the electronic devices. That is, since the camera modules include parts like lenses and image sensors for realizing the photographing function, it is natural that these parts should be adjusted and assembled in factories specialized in these techniques so that mobile phone factories, for example, can concentrate on works for enhancing the quality of mobile phones' original functions.

Thus, in the manufacture of electronic devices having an additional camera function, the main modules for realizing original functions of the electronic devices and the camera modules for realizing the additional camera function are produced as separate parts as independently as possible, and are assembled together in the final stage.

Now, the size of mobile phone devices and personal digital assistants is decreasing. This requires higher degrees of integration of parts in the main modules and camera modules in order to add the camera function while promoting the size reduction of the electronic devices.

FIG. 4 is a block diagram of an electronic device with a camera according to a background art. This electronic device includes a camera module 5 and a main module 6. The camera module 5 includes a camera board 50 and parts mounted on the camera board 50, and the main module 6 includes a main board 60 and parts mounted on the main board 60.

The camera module 5 includes a lens 51 for leading images of subjects, an image sensor 52 for converting into an image signal the subjects' images led through the lens 51, an EPROM 53 for storing adjustment data for the camera module 5, and an A/D converter circuit 54 for digital-converting the image signal outputted from the image sensor 52.

The main module 6 includes an image processing unit 61 for applying image processing to the image signal provided from the camera module 5, an SDRAM 62 used as a work area for the execution of a program for controlling the image processing unit 61, a main processing unit 63 for executing original functions of the electronic device, and a flash memory 64 for storing the program for controlling the image processing unit 61.

Thus, the electronic device with a camera shown in FIG. 4 includes separated parts, where the camera module 5 is produced in a camera manufacturing factory and the main module 6 is produced in an electronic device manufacturing factory, and the parts are assembled together in the final stage. In this structure, the program stored in the flash memory 64, i.e., the program for controlling the image processing unit 61, is adapted for the camera module 5. That is, it is necessary to prepare different programs for different types of camera modules 5. Accordingly, when the structure of the camera module 5 is changed, e.g., when the image sensor 52 is changed to another model, it is then necessary to rewrite the program stored in the flash memory 64. Thus, a change of the camera module 5 requires a change of the main module 6, which results in additional manufacturing process and increased manufacturing costs. This problem is particularly serious when a large number of main modules 6 are in stock.

In order to solve this problem, an electronic device with a camera may be configured as shown in FIG. 5. This electronic device can be divided into a camera module 5A and a main module 6A. This electronic device differs from that shown in FIG. 4 in that the camera module 5A includes an image processing unit 55, an SDRAM 56, and a flash memory 57. That is, while the electronic device shown in FIG. 4 incorporates the image processing unit, SDRAM, and flash memory in the main module, the electronic device of FIG. 5 incorporates these components in the camera module 5A.

The flash memory 57 stores a program for controlling the image processing unit 55. Also, the flash memory 57 stores adjustment data for the camera module 5A. In this configuration, because the programs that must be changed according to a change of the camera module 5 are stored in the flash memory 57, the parts related to the camera function can all be separated from the main module 6A, which is advantageous in that a change of the camera module 5A does not affect the main module 6A.

However, as mentioned above, because of the downsizing of the electronic device to which the camera function is added, the configuration shown in FIG. 5 requires a higher degree of integration of a large number of parts in the small camera module 5A. This leads to the problem that the image sensor 52 suffers from increased noise because of a temperature rise. When a large number of electronic parts are mounted in the camera module 5A and these electronic parts operate to raise the temperature of the camera module 5A, then the amount of generated charge in the charge accumulation part of the image sensor 52 increases to produce increased noise, which deteriorates the quality of the output image signal. Particularly, the provision of a relatively high-power consuming part, such as the image processing unit 55, considerably increases the temperature and more seriously affects the image sensor 52.

Also, in the configuration shown in FIG. 5, the image signal processed in the image processing unit 55 is transferred to the main module 6A through a YUV interface. This is because the camera module 5A and the main module 6A are generally connected through a flexible cable and so it is difficult to connect the modules through a host interface.

Thus, JPEG image data generated in the image processing unit 55, for example, is transferred to the main module 6A through the YUV interface. At this time, if an interrupt for the electronic device's original operation occurs in the main module 6A, the data reception may fail because the rate of data transfer through the YUV interface is low. For example, when the electronic device is a mobile phone device and a telephone call is received in the main module 6A during the transfer of JPEG image data, some data may be properly recieved.

Also, providing the image processing unit in the camera module involves CPU processing and other hardware processing on the camera module side. Accordingly, the camera module produces more switching noise than that shown in FIG. 4, which also adversely affects the image sensor.

Japanese Patent Application Laid-Open No. 2004-312433 discloses an image processing system having a camera section and a main body separated from each other. However, in this system, the IC for executing the image processing is provided in the camera section, so that, as in the structure shown in FIG. 5, the parts in the camera section are highly integrated in the downsized electronic device. Thus, the problem that the temperature rise increases the noise of the image sensor remains unsolved.

### SUMMARY OF THE INVENTION

Concerning electronic devices that are increasingly downsized and that are equipped with a camera function, an object of the present invention is to provide a technique for constructing such electronic devices without requiring additional manufacturing process and increased costs for the parts, and without deteriorating image quality.

According to the present invention, an electronic device includes: a camera module; and a main module including a component for realizing an original function of the electronic device, where the camera module includes: a lens that leads an image of a subject; an image sensor that converts into an image signal the image of the subject led through the lens; and a nonvolatile memory, and the main module includes: an image processing unit that applies image processing to the image signal provided from the camera module; and a volatile memory, and wherein the image processing unit is controlled according to a program that is adapted for the camera module, and the program is stored in the nonvolatile memory; an interface is provided between the camera module and the main module in order to transfer the program; and the program is transferred from the camera module to the main module through the interface and then executed with the volatile memory used as a work area.

The present invention relates also to a main module that is incorporated in an electronic device equipped with a camera function and that includes a component for realizing an original function of the electronic device.

According to the present invention, the main module includes an image processing unit, and a program for controlling the image processing unit is stored in the camera module. Therefore, when the camera module is modified or changed, it is not necessary to modify the main module, which makes it possible to use the main module as a common module. Also, since the image processing unit is not disposed in the camera module, the influence of increased noise of the image sensor is alleviated.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a mobile camera phone device according to a preferred embodiment;

FIG. 2 is a diagram showing the appearance of the camera module and the main module;

FIG. 3 is a diagram showing another preferred embodiment of the mobile camera phone device;

FIG. 4 is a block diagram of an electronic device equipped with a camera according to a background art; and

FIG. 5 is a block diagram of an electronic device equipped with a camera according to a background art.

### DESCRIPTION OF THE PREFERRED EMBODIMENTS

Preferred embodiments of the present invention will now be described referring to the drawings. The preferred embodiments will describe examples in which the inventive electronic device equipped with a camera is applied to a mobile camera phone device 4.

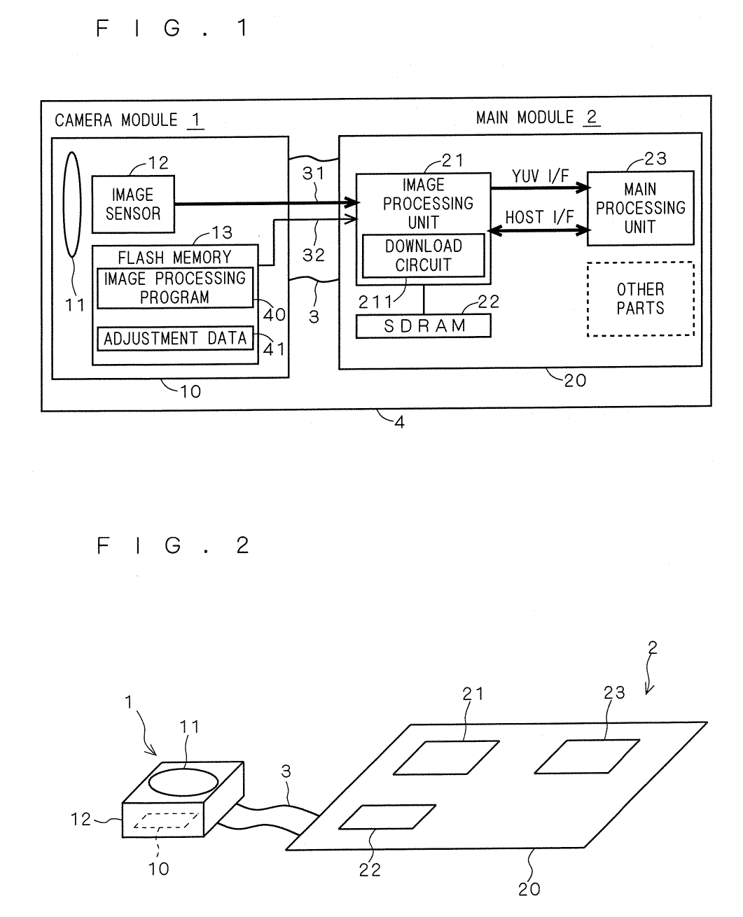

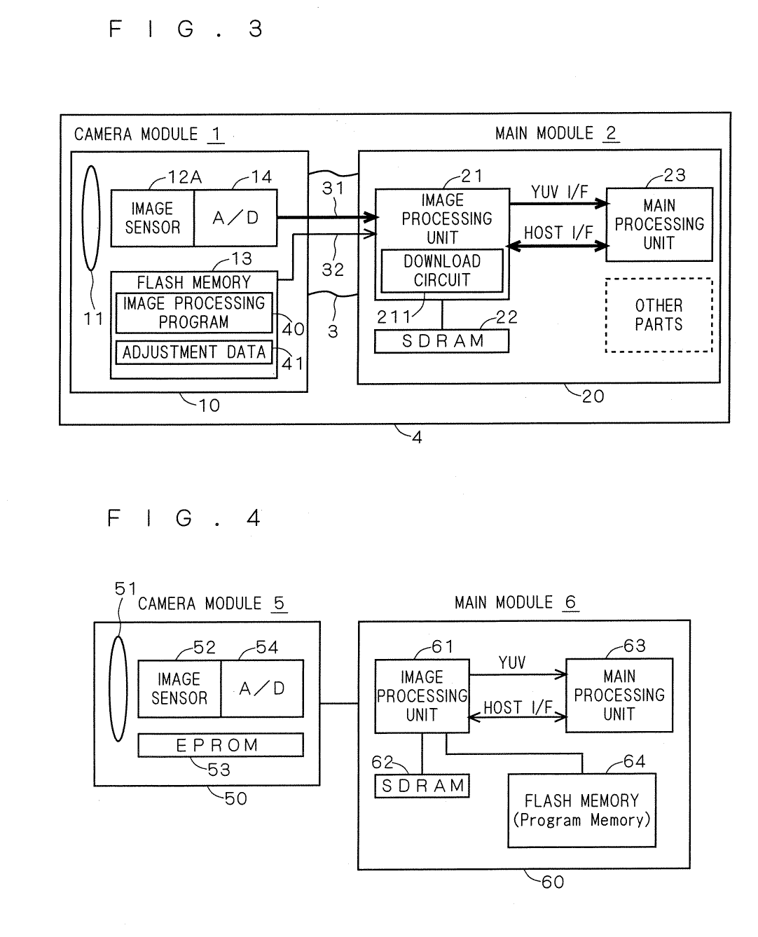

As shown in FIG. 1, the mobile camera phone device 4 includes a camera module 1 and a main module 2. The camera module 1 includes a camera board 10 and various parts mounted on the camera board 10. The main module 2 includes a main board 20 and various parts mounted on the main board 20. As shown in FIG. 2, the camera module 1 and the main module 2 are connected through a flexible cable 3. The camera module 1 and the main module 2 thus connected are accommodated in the housing of the mobile phone device to form the mobile camera phone device 4.

Referring to FIG. 1 again, the camera module 1 includes a lens 11 that leads images of subjects, an image sensor 12 that converts into an image signal the images of subjects led by the lens 11, and a flash memory 13. The image sensor 12 is a CCD sensor or a CMOS sensor, for example. The image sensor 12 includes analog signal processing circuits such as a CDS (Correlated Double Sampling) circuit and an AGC (Automatic Gain Control) circuit, and an A/D converter circuit, and the image sensor 12 converts an analog-processed image signal into a digital signal and outputs it. The flash memory 13 contains an image processing program 40 and adjustment data 41.

While this preferred embodiment uses a flash memory (flash ROM) having a serial interface in order to store the image processing program 40 etc., any rewritable nonvolatile memory may be used. For example, other EEPROM or EPROM may be used. Also, a flash memory having a parallel interface may be used.

The main module 2 includes an image processing unit 21 that applies image processing to the image signal provided from the camera module 1, an SDRAM 22 that is used as a work area for the execution of the image processing program 40 for controlling the image processing unit 21, and a main processing unit 23 that controls the entirety of the mobile camera phone device 4. While an SDRAM is used as the program executing area, other volatile memory may be used.

The image processing unit 21 is configured as an LSI having a CPU for executing the image processing program 40 and hardware circuitry for performing various image processings. The hardware circuitry for performing various image processings includes a color space converter circuit, a pixel interpolation circuit, a shading correction circuit, and the like. The main processing unit 23 is configured as an LSI having a CPU for controlling the entirety of the mobile camera phone device 4 and hardware circuitry for performing various processings.

The image processing unit 21, the main processing unit 23, and the SDRAM 22 are mounted on the main board 20 and connected through signal lines. As shown in the diagram, the image processing unit 21 and the main processing unit 23 are connected through a YUV interface and a host interface.

The main module 2 further includes various other parts. For example, the main module 2 includes parts for performing the original function of the mobile camera phone device 4, i.e., telephoning function, and parts for processing the communication. The main module 2 is connected to various parts including operating buttons, a microphone, speaker, LCD, etc. Thus, the main module 2 includes various kinds of parts that realize original functions as a mobile phone device.

Operations of the mobile camera phone device 4 thus structured will be described. When the mobile camera phone device 4 is performing its original function as a mobile phone device, e.g., when the mobile camera phone device 4 is processing a call, no power is supplied to the camera module 1, the image processing unit 21, and the SDRAM 22. Then, when the user operates the mobile camera phone device 4 to turn on the camera function, power is supplied to the camera module 1, the image processing unit 21, and the SDRAM 22.

When power is thus supplied to the parts related to the camera function, a download circuit 211 included in the image processing unit 21 starts downloading of the image processing program 40. The image processing program 40 is a program that controls the image processing unit 21 and is adapted for the camera module 1. That is, it is necessary to prepare the image processing program 40 in correspondence with the structure of the camera module 1 or the model of the image sensor 12. In this preferred embodiment, the image processing program 40 is stored in the flash memory 13 that is provided in the camera module 1.

As shown in FIG. 1, the flexible cable 3, connecting the camera module 1 and the main module 2, includes a parallel signal line 31 for transferring the image signal outputted from the image sensor 12 and a serial signal line 32 for transferring the image processing program 40 stored in the flash memory 13. The signal line 31, for transferring the image signal, is a 10-bit-wide or 12-bit-wide signal line, for example. When the download circuit 211 transfers a download command through the serial signal line 32, the image processing program 40 is transferred to the main module 2 through the serial signal line 32 and stored in the SDRAM 22. In this way, the camera module 1 and the main module 2 of this preferred embodiment have a dedicated interface for the transfer of the program. The flash memory 13 may be formed of a memory having a parallel interface, with a program downloading interface formed of a parallel interface.

Then, the CPU in the image processing unit 21 executes the image processing program 40 while using the SDRAM 22 as a work area. In this way, the image signal outputted from the camera module 1 is transferred to the image processing unit 21 through the signal line 31, and the image processing unit 21 performs various image processings.

The flash memory 13 further stores the adjustment data 41 peculiar to the camera module 1. The adjustment data 41 is data that is peculiar to various parts of the camera module 1. For example, the adjustment data 41 includes defect pixel data about the image sensor 12, characteristic data about output level caused by variations among individual optical system components such as IIR filters and sensors, R, G, B output level variation characteristic data obtained when a reference light source is used, optical shading characteristic data about the lens, and the like.

When the camera function is turned on, the download circuit 211 downloads the adjustment data 41 through the signal line 32 and stores the adjustment data 41 in the SDRAM 22. Then, the image processing unit 21 performs image processing according to the adjustment data 41 or by using the adjustment data 41 as parameters. For example, defect pixel correction processing is performed on the basis of the defect pixel data. Also, shading correction processing is performed on the basis of the optical shading characteristic data. Thus, the image processing program 40, adapted for the camera module 1, is executed while considering information peculiar to the camera module 1.

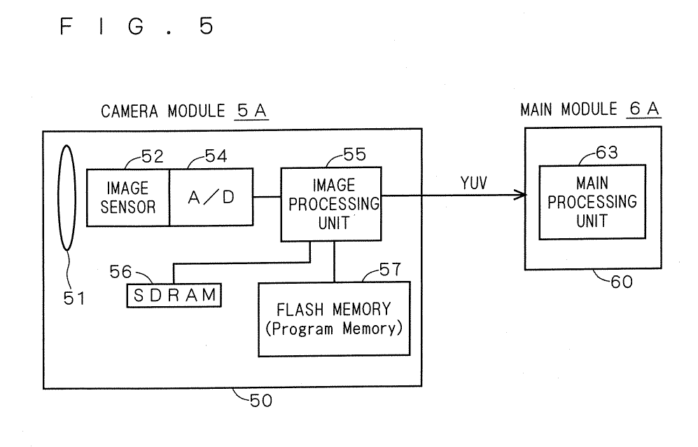

The mobile camera phone device 4 according to this preferred embodiment is configured as described so far, and offers the effects shown below. Firstly, the image processing program 40 adapted for the camera module 1 is stored within the camera module 1. Accordingly, even when the structure of the camera module 1 is changed and the contents of the image processing program 40 must be changed accordingly, the change requires only changing the camera module 1. That is, it is not necessary to change the main module 2 when the structure of the camera module 1 is changed. This allows the main module 2 to be used as a common module, regardless of the model of the camera module 1. The use of the main module 2 as a common module reduces the risk of overstocking when the main module 2 is mass-produced, which will allow reduction of costs. The first effect solves the problem of the structure according to the background art described referring to FIG. 4. Also, this allows the omission of the EPROM that is used in the configuration of FIG. 4, which is advantageous in both of the cost reduction and size reduction of the device.

Secondly, the number of parts of the camera module 1 is reduced since it does not include the image processing unit. Particularly, the absence of the image processing unit, whose CPU processing causes temperature rise, alleviates the influence of increased noise of the image sensor 12, thus enhancing the quality of the outputted image signal. The second effect solves the problem of the configuration according to the background art described referring to FIG. 5. Thus, in the mobile camera phone device 4 of this preferred embodiment, the parts mounted in the camera module 1 and the main module 2 are arranged in a well-balanced manner, without excessive concentration in either module, and the problems of both of the electronic devices according to the background art shown in FIGS. 4 and 5 are solved.

Also, in this preferred embodiment, the adjustment data 41 for the camera module 1 is stored in the flash memory 13 of the camera module 1. Accordingly, adjustments of parts mounted in the camera module 1 are performed during the manufacturing process of the camera module 1, and the results of adjustments are stored in the camera module 1 itself, so that the manufacturing process can be independently completed just with the camera module 1.

Furthermore, this preferred embodiment has the advantage that, because the image processing unit 21 is provided in the main module 2, data can be transferred through the host interface to and from the main processing unit 23 that controls the entire mobile camera phone device 4. More specifically, mounting the image processing unit 21 and the main processing unit 23 on the same main board 20 allows the units to be readily connected through the host interface.

It is thus possible to transfer data, e.g., JPEG image data generated in the image processing unit 21, to the main processing unit 23 through the host interface. Even when an interrupt like arrival of a phone call occurs in the main processing unit 23 during an operation of the camera function, the data transfer is certainly carried out without loss of data. It is also possible to transfer an image, inputted from the camera module 1, to the main processing unit 23 through the YUV interface and cause the main processing unit 23 to make a display of moving picture on the LCD, in parallel with a JPEG image data transfer through the host interface.

Mounting the image processing unit 21 in the main module 2 produces another effect. In most cases, display control to the LCD of the mobile camera phone device 4 is performed on the main processing unit 23 side, and the main processing unit 23 has a display controller for the LCD. Accordingly, in the mobile camera phone device 4 according to this preferred embodiment, a display controller is added also to the image processing unit 21. Then, a selector is connected to the two display controllers so that one of the signals is outputted to the LCD. That is, this configuration is made possible by the provision of the image processing unit 21 and the main processing unit 23 on the same board 20. When the selector is connected to the display controller provided for the image processing unit 21, images transferred from the camera module 1 can be displayed directly on the LCD without being controlled by the main processing unit 23. This configuration makes it possible to make a live view display on the LCD without applying loads on the main processing unit 23.

FIG. 3 is a diagram showing another preferred embodiment of the present invention. While the image sensor 12 of the preferred embodiment of FIG. 1 contains an A/D converter circuit, the image sensor 12A of this preferred embodiment does not contain an A/D converter circuit. Accordingly, the camera module 1A includes an A/D converter circuit 14 separately from the image sensor 12A. In other respects, the configuration is the same as that shown in FIG. 1.

While the preferred embodiments of the present invention have described a mobile phone device equipped with a camera as an example, the present invention offers the corresponding effects also when applied to other electronic devices having a camera function in addition to their original functions, such as personal digital assistants equipped with cameras. The effects are more significant especially with electronic devices whose downsizing is in growing demand.

While the invention has been described in detail, the foregoing description is in all aspects illustrative and not restrictive. It is understood that numerous other modifications and variations can be devised without departing from the scope of the invention.

What is claimed is:

1. An electronic device, comprising:
a camera module; and
a main module that includes a component for realizing an original function of said electronic device,
said camera module comprising
a lens that leads an image of a subject;
an image sensor that converts into an image signal the image of the subject led through said lens; and
a nonvolatile memory,
said main module comprising
an image processing unit that applies image processing to the image signal provided from said camera module; and
a volatile memory,
wherein said image processing unit is controlled according to a program that is adapted for said camera module, said program being stored in said nonvolatile memory,
an interface is provided between said camera module and said main module in order to transfer said program, and
said program is transferred from said camera module to said main module through said interface and then executed with said volatile memory used as a work area.

2. The electronic device according to claim 1, wherein said nonvolatile memory stores data that is peculiar to said camera module.

3. The electronic device according to claim 2, wherein said data includes adjustment data about a component included in said camera module.

4. The electronic device according to claim 1, wherein said camera module further comprises an A/D converter circuit.

5. The electronic device according to claim 1, wherein said electronic device equipped with a camera is a mobile phone device equipped with a camera function.

6. The electronic device according to claim 5, wherein said main module comprises a main processing unit that controls said mobile phone device as a whole.

7. The electronic device according to claim 6, wherein said main module comprises a host interface and a YUV interface that transfer data between said image processing unit and said main processing unit.

8. The electronic device according to claim 1, wherein said main module downloads said program from said nonvolatile memory at a time when the camera function of said electronic device is started.

9. A main module that is incorporated in an electronic device equipped with a camera function and that includes a component for realizing an original function of said electronic device, said main module comprising:
an image processing unit that receives an image signal outputted from a camera module incorporated in said electronic device and that applies image processing to the image signal; and
a volatile memory,
wherein said image processing unit is controlled according to a program adapted for said camera module, said program being stored in said camera module,
said main module further comprises an interface that downloads said program from said camera module when the camera function is started, and
an operation corresponding to said camera module is performed by executing said program which is downloaded while using said volatile memory as a work area.
